(19) United States
(12) Patent Application Publication
(10) Pub. No.: US 2020/0355914 A1
(43) Pub. Date: Nov. 12, 2020

(54) HEAD-UP DISPLAY

(71) Applicant: VALEO COMFORT AND DRIVING ASSISTANCE, Crêteil (FR)

(72) Inventors: Bruno Albesa, Créteil (FR); Michael Irzyk, Créteil (FR)

(73) Assignee: VALEO COMFORT AND DRIVING ASSISTANCE, Créteil (FR)

(21) Appl. No.: 16/068,050

(22) PCT Filed: Jan. 4, 2017
(86) PCT No.: PCT/EP2017/050165

§ 371 Date: Jun. 2, 2020

(30) Foreign Application Priority Data
Jan. 4, 2016 (FR) 1650017

(51) Int. Cl. G02B 27/01; G02B 3/00; G02B 30/26

(52) U.S. Cl. CPC G02B 27/0101; G02B 3/0006; G02B 2027/0183; G02B 2027/0163; G02B 2027/014; G02B 30/26

(57) ABSTRACT

The invention relates to a head-up display (10) for a motor vehicle, comprising: —a computer (20), —an imaging unit (11) controlled by the computer so as to generate images, and—an optical unit (12) for projecting virtual images (Img), designed to project every image generated by the imaging unit in the field of vision of the motor vehicle driver. According to the invention, the imaging unit comprises an autostereoscopic filter (16).

### TECHNICAL FIELD TO WHICH THE INVENTION RELATES

The present invention generally relates to devices for assisting with driving motor vehicles.

It more particularly relates to a head-up display for a motor vehicle, said head-up display comprising:
a computer;
an image-generating unit controlled by the computer in order to generate images; and
an optical assembly for projecting virtual images, which is suitable for projecting each image generated by said image-generating unit into the field of view of the driver of the motor vehicle.

### TECHNOLOGICAL BACKGROUND

To facilitate and make driving a motor vehicle safer, it is desired to prevent the driver from being forced to divert his gaze from the route that he is taking.

To this end, it is known to use a head-up display, suitable for projecting elementary information (speed of the vehicle, direction to follow, etc.) and safety information (engine fault, presence of an obstacle, etc.) at the height of the gaze of the driver.

Two types of head-up displays are in particular known.

Displays of the first type use an image-forming device comprising a diffuser and a scanning unit that is designed to generate a light beam that scans an entrance face of the diffuser. The light beam output from the diffuser thus forms an image, which may then be projected into the field of view of the driver of the vehicle by means of a combiner.

Displays of the second type use a screen that allows an image to be generated, which image is then projected into the field of view of the driver, here also by means of a combiner.

In both cases, the combiner allows it to be made so that the driver is able to perceive elementary and safety information in superposition on the view that he has of the road. The driver then perceives this information as though it were displayed in a plane located at a distance from the driver larger than the distance separating the driver from the windshield.

A system has also been developed that allows two images to be displayed in two different planes, this allowing the driver to perceive information as though it were displayed in two planes that are relatively far from him. This type of system, since it uses two projecting optics, does not allow a three-dimensional image to be produced, but only two-dimensional information to be displayed in different planes.

Another system in particular uses two screens associated with two prisms that allow two distinct images to be obtained at the same distance from the driver, one of which is visible by the right eye of the driver and the other of which is visible by the left eye of the driver leading thus to the three-dimensional perception of the projected content.

This system has two major drawbacks. It firstly has a high cost. It moreover limits to two the number of planes into which it is possible to project information.

### SUBJECT OF THE INVENTION

In order to remedy the aforementioned drawbacks of the prior art, according to the invention a head-up display for a motor vehicle is proposed, said head-up display comprising:
a computer;
an image-generating unit controlled by the computer in order to generate images; and
an optical assembly for projecting virtual images, which is suitable for projecting each image generated by said image-generating unit into the field of view of the driver of the motor vehicle, and wherein the image-generating unit includes an auto-stereoscopic filter, said image-generating unit offering at least two distinct view points.

Thus, by virtue of the invention, the filter will allow images to be generated that will be perceived by the driver as being three-dimensional. It will therefore be possible to display information in an infinite number of planes that are relatively far from the driver.

The following are other advantageous and nonlimiting features of the head-up display according to the invention:
the auto-stereoscopic filter includes an array of microlenses;
said image-generating unit offers eight distinct view points;
as a variant, the auto-stereoscopic filter includes a parallax barrier;
the computer is suitable for controlling the image-generating unit in such a way that the virtual images projected by the optical assembly are perceived by the driver as being formed of tracings (Img1, Img2, Img3), each tracing (Img1, Img2, Img3) being located in a distinct plane and comprising information that is visible to the driver;
the computer is suitable for controlling the image-generating unit in such a way that the virtual images projected by the optical assembly are perceived by the driver as representing a three-dimensional shape;
provision is made to place at the disposal of the driver a means for inputting data, which is connected to the computer and which allows the driver to switch the computer between two computing modes, namely an active mode in which the computer controls the image-generating unit in such a way that the virtual images projected by the optical assembly are perceived by the driver as being three-dimensional, and a passive mode in which the computer controls the image-generating unit in such a way that each virtual image projected by the optical assembly is seen by the driver as being two-dimensional;
provision is made for a system for detecting the position of each of the eyes of the driver, and the computer is suitable for controlling the image-generating unit depending on the detected position of said eyes;
said image-generating unit comprises a display screen;
said projecting optical assembly includes at least one magnifying optical component; and
said projecting optical assembly includes a combiner taking the form of a semi-reflective and transparent curved optical window performing a magnifying function.

### DETAILED DESCRIPTION OF ONE EMBODIMENT

The following description, which is given with reference to the appended drawings, which are given by way of nonlimiting example, will allow of what the invention consists and how it may be carried out to be clearly understood.

In the appended drawings:

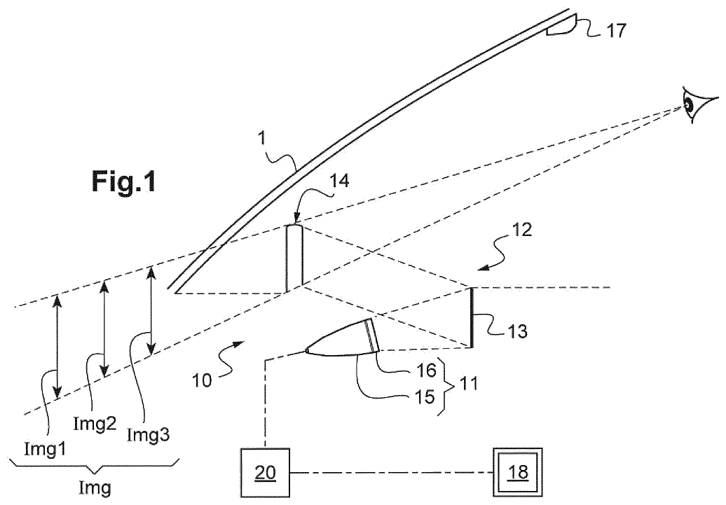

FIG. 1 is a schematic view of a head-up display according to the invention; and

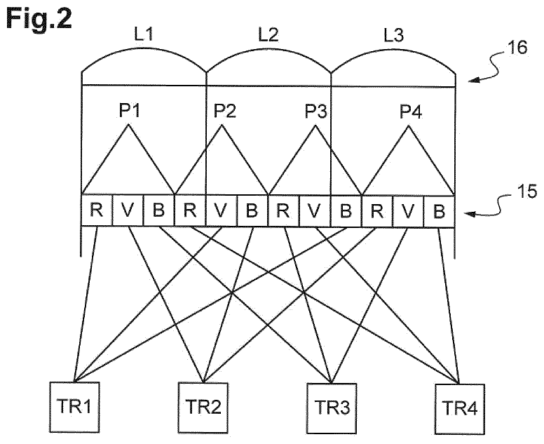

FIG. 2 is a schematic view of a portion of a screen of an auto-stereoscopic filter of the head-up display of FIG. 1.

FIG. 1 shows a head-up display 10 with which a vehicle, for example a motor vehicle, is intended to be equipped.

This head-up display 10 comprises an image-generating unit 11 that is driven by a computer 20, and a projecting optical assembly 12.

In the embodiment illustrated in FIG. 1, the image-generating unit 11 comprises a display screen 15, here a thin-film transistor (TFT) liquid-crystal display (LCD). It also comprises a backlighting device located behind the display screen 15. This image-generating unit 11 allows, under the control of the computer 20, an image to be generated that the projecting optical assembly 12 will be able to project into the field of view of the driver when the gaze of the latter is turned toward the road.

Thus, the projecting optical assembly 12 is more precisely designed to project a virtual image Img into the field of view of the driver of the vehicle.

It includes to this end a steering optical system 13 and a combiner 14 that is placed in the field of view of the driver of the vehicle. It could optionally also include a magnifying lens (not shown).

The steering optical system 13, which here includes only a folding mirror, allows the image generated by the image-generating unit 11 to be steered toward the combiner 14.

The combiner 14 allows this image to be reflected in such a way that it appears to the driver.

Here, this combiner 14 is preferably placed in the passenger compartment of the motor vehicle, between the windshield 1 of the vehicle and the eyes of the driver. As a variant, the combiner could be formed by the windshield itself.

This combiner 14 includes a semi-reflective and transparent curved optical window performing a magnifying function. Here, it is a question of an injection-molded part made of polycarbonate that is curved so as to increase the size of the virtual image Img seen by the driver.

The computer 20 for its part comprises a processor and a storage unit, for example a rewritable nonvolatile memory or a hard disk.

The storage unit in particular stores a computer application made up of computer programs comprising instructions the execution of which by the processor allows the method described above to be implemented by the computer 20.

The computer 20 is in particular able to control the display screen 15 so that the latter displays images.

This computer 20 is preferably connected to a system 17 for detecting the position of each of the eyes of the driver and to a means 18 for inputting data, which is placed at the disposal of the driver.

Typically, the detecting system 17 may be formed by a video camera that acquires images of the face of the driver. Provision will then be made for the computer 20 to determine the instantaneous position of each of the eyes of the driver, on the basis of the acquired images.

The inputting means 18 may for its part be formed by a bistable button that is actuatable by the driver. Here, this inputting means will rather be considered to be formed by a touchscreen placed in the central console of the motor vehicle.

Here, and this is more precisely the subject of the present invention, the head-up display 10 is designed in such a way that the virtual images Img projected into the field of view of the driver are three-dimensional images. These images are more precisely intended to be seen in three dimensions by the driver, without requiring him to wear stereoscopic glasses (more widely known as “3D glasses”).

To this end, the image-generating unit 11 includes an auto-stereoscopic filter 16.

Provision is then made for the computer 20 to control the display of images by the display screen 15 taking into account characteristics of this auto-stereoscopic filter 16, so that the virtual images Img are perceived by the driver as being three-dimensional.

The auto-stereoscopic filter could take the form of a parallax barrier.

Here, preferably, the auto-stereoscopic filter rather takes the form of an array of convergent microlenses offering at least two distinct view points.

By “distinct view points”, what is meant is that the image-generating unit 11 is suitable for simultaneously displaying, interleaved, at least two different two-dimensional images, each being observable individually at a different angle from the angle of which the other image is observable.

In this way, the driver will be able to simultaneously observe two two-dimensional images with his two eyes, so that his brain will be able to reconstruct a three-dimensional image.

In one preferred embodiment, more than two view points, namely here eight view points, will be offered. In this way, the driver will be able to observe, from among the eight available, two two-dimensional images with his two eyes not only when his head is exactly positioned on the axis of the combiner 14, but also when it is shifted with respect to this axis.

In FIG. 2, with a view to briefly explaining the operation of this auto-stereoscopic display system, a portion of the display screen 15 and of the auto-stereoscopic filter 16 has been shown, in cross section and very schematically.

It may be seen therein that the display screen 15 includes a periodic succession of sub-pixels of different colors: red (R), green (G) and blue (B). Each triplet of sub-pixels forms one pixel P1, P2, P3, P4.

Each sub-pixel has, face-on, a rectangular shape or, as will be described below, a parallelogram shape.

Each sub-pixel is controlled to emit, from its front face, light with a defined light intensity, the sensation of color then resulting from the mixture of the three elementary colors in the eye of the driver.

The array of microlenses is for its part composed of micro lenses L1, L2, L3, which here are cylindrical. It is in practice a question of lenses that are profiled along a vertical axis and of convex transverse cross section. In the example illustrated in the figures, these lenses here have a planar back face (face oriented toward the display screen 15) and a convex front face. As a variant, it could be otherwise.

The array of micro lenses is placed in front of the display screen 15, parallel to the latter, at a distance equal to the focal length of the micro lenses. Thus, the microlenses L1, L2, L3 of the array magnify points horizontally and steer to infinity visual information present on the screen.

In the example embodiment of FIG. 2, for the sake of clarity, an image-generating unit 11 that offers a number of view points TR1, TR2, TR3, TR4 equal to 4 has been shown.

Four pixels P1, P2, P3, P4 that are juxtaposed horizontally have been shown in this figure.

Three microlenses L1, L2, L3 have also been shown. The pitch of these microlenses L1, L2, L3 is here chosen equal to the width (measured horizontally) of four sub-pixels.

The four view points TR1, TR2, TR3, TR4 at which it is possible to observe the image-generating unit 11 have also been shown. For the sake of clarity of FIG. 2, these four view points are shown on the side of the display screen 15 whereas, in practice, this screen will be seen from the opposite side through the projecting assembly 12.

A (single) eye that observes the display screen 15 through the array 16 of microlenses will then see, depending on its position:
either the juxtaposition of the red component R of the pixel P1, of the green component G of the pixel P2 and the blue component B of the pixel P3 (point of view TR1);
or the juxtaposition of the green component G of the pixel P1, of the blue component B of the pixel P2 and the red component R of the pixel P4 (point of view TR2);
or the juxtaposition of the blue component B of the pixel P1, of the red component R of the pixel P3 and the green component G of the pixel P4 (point of view TR3);
or lastly the juxtaposition of the red component R of the pixel P2, of the green component G of the pixel P3 and the blue component B of the pixel P4 (point of view TR4).

In other words, each eye of the driver is liable to visually mix the red, green and blue components of various pixels of the image.

In this way, by cleverly controlling the light intensity emitted by each sub-pixel, the computer may display images that, because they will not be seen at the same angle (i.e. with the same point of view) by the two eyes of the driver, will possibly be interpreted by the brain as three-dimensional images.

As was described above, the image-generating unit 11 will preferably be designed to offer not four, but eight different view points. To this end, micro lenses each covering not four but eight sub-pixels will be used.

Nonlimitingly, the sub-pixels are elongate along a vertical axis but, the micro lenses are elongate along an axis that is inclined by an angle α with respect to the vertical axis so as to produce groupings of eight sub-pixels.

The way in which the computer 20 controls the image-generating unit 11 will now be described in detail.

To this end, “frontal planes” will first be defined as planes that lie substantially orthogonally to the direction of the gaze of the driver. Each frontal plane will then be defined by a “depth”, i.e. by a distance separating it from the eyes of the driver.

In the illustrated embodiment, the computer 20 will control the image-generating unit 11 in such a way that each virtual image Img projected by the optical assembly 12 is seen by the driver as being made up of points located in a finite number of distinct frontal planes, this number for example being lower than or equal to five.

It is possible here to envision the case in which the number of frontal planes is equal to three.

Each image Img will then be generated in such a way that it includes three portions (called “tracing Img1, Img2, Img3”) each of which will be interpreted by the brain of the driver as being contained in a different frontal plane. Preferably, the tracing Img3 closest to the driver will be seen as being located at a distance from the driver larger than the distance separating the driver from the windshield 1, so that the eyes of the driver will not have to do any work accommodating to perceive the projected information.

Provision may thus be made for one of the tracings Img3 to be seen by the driver to be located at 4 meters from him, for a second of the tracings to be seen to be located at 5 meters from him and for the third of the tracings to be seen to be located at 6 meters from him.

Each tracing will possibly be used to display distinct information. Thus provision will for example be made to display the speed of the vehicle on the closest tracing Img3, to display geo-positioning information on the second tracing Img2 and to display obstacle-detection information on the furthest tracing Img1.

Provision could also be made for the computer 20 to control the image-generating unit 11 in such a way that a virtual image Img, projected by the optical assembly 12, represents a three-dimensional shape perceived as such by the driver. By way of nonlimiting example, such a three-dimensional shape could be a sphere, a motor vehicle, a continuous white line or even the symbolism of a road scene. In this case, the depth of the three-dimensional shape of the virtual image Img will be calculated so that successive points of the three-dimensional shape appear to be continuous.

A three-dimensional shape represents an object including at least one surface that extends continuously over a depth, whereas the aforementioned tracings form a three-dimensional image because of their arrangement in planes that are orthogonal to the direction of the gaze and located at different depths.

A virtual image will thus possibly represent at least one three-dimensional shape and/or an image formed of one or more tracings located at different depths.

A driver may prefer the image that he perceives to be two-dimensional rather than three-dimensional.

The driver will possibly in this case use the touchscreen 18 of the central console of the vehicle to switch the computer 20 from a normal operating mode (called the active mode), such as the aforementioned, to a degraded mode (called the passive mode). In this degraded mode, the computer 20 will then be designed to control the image-generating unit 11 in such a way that each virtual image Img projected by the optical assembly 12 is formed from a single tracing.

In this case, if FIG. 2 is referred to, the computer will control the illumination of the sub-pixels of the display screen 15 in such a way that the mixture of R, G, B colors seen through each triplet of micro lenses L1, L2, L3 is the same, whatever the point of view from which the display screen 15 is observed.

In this way, the two eyes of the driver will possibly observe the same image, which will be interpreted by the brain of the driver as being a two-dimensional image.

The present invention is in no way limited to the embodiment described and shown, and those skilled in the art will be able to apply thereto any variant according to the invention.

Thus, the computer 20 will possibly control the image-generating unit 11 depending on the detected position of the eyes of the driver.

Specifically, if FIG. 2 is referred to, it is necessary, for the driver to see the virtual image clearly, for each of his two eyes to be located at one of the view points TR1, TR2, TR3, TR4.

At least one of the eyes of the driver may be slightly shifted laterally with respect to these view points.

In this case, the computer will possibly, on account of the position of each of the two eyes of the driver (which position is detected by virtue of the detecting system 17), laterally shift at least one of the images seen by one of the eyes of the driver so that the virtual image observed by the driver is clear. In another variant of the invention, it will be possible to display information at a distance from the driver that is variable and that will be chosen depending on the type of information to be displayed or depending on the encountered conditions. By way of example, the speed of the vehicle may be displayed in a frontal plane the distance of which from the driver will depend on the speed at which the vehicle is moving.

1. A head-up display for a motor vehicle, said head-up display comprising:
a computer;
an image-generating unit controlled by the computer to generate images; and
an optical assembly for projecting virtual images, wherein each image generated by said image-generating unit is projected into the field of view of the driver of the motor vehicle,
wherein the image-generating unit includes an auto-stereoscopic filter and said image-generating unit offers at least two distinct view points.

2. The head-up display as claimed in claim 1, wherein the auto-stereoscopic filter includes an array of microlenses.

3. The head-up display as claimed in claim 2, wherein said image-generating unit offers eight distinct view points.

4. The head-up display as claimed in claim 1, wherein the auto-stereoscopic filter includes a parallax barrier.

5. The head-up display as claimed in claim 1, wherein the computer is for controlling the image-generating unit in such a way that the virtual images projected by the optical assembly are perceived by the driver as being formed of tracings, each tracing being located in a distinct plane and comprising information that is visible to the driver.

6. The head-up display as claimed in claim 1, wherein the computer is for controlling the image-generating unit in such a way that the virtual images projected by the optical assembly are perceived by the driver as representing a three-dimensional shape.

7. The head-up display as claimed in claim 1, wherein provision is made to place at the disposal of the driver a means for inputting data, which is connected to the computer and which allows the driver to switch the computer between two computing modes, comprising:
an active mode in which the computer controls the image-generating unit in such a way that the virtual images projected by the optical assembly are perceived by the driver as being three-dimensional; and
a passive mode in which the computer controls the image-generating unit in such a way that the virtual images projected by the optical assembly are seen by the driver as being two-dimensional.

8. The head-up display as claimed in claim 1, including a system for detecting the position of each of the eyes of the driver, and wherein the computer is suitable for controlling the image-generating unit depending on the detected position of said eyes.

9. The head-up display as claimed in claim 1, wherein said image-generating unit comprises a display screen.

10. The head-up display as claimed in claim 1, wherein said projecting optical assembly includes at least one magnifying optical component.

11. The head-up display as claimed in claim 1, wherein said projecting optical assembly includes a combiner taking the form of a semi-reflective and transparent curved optical window performing a magnifying function.
